(19) United States
(12) Patent Application Publication
(10) Pub. No.: US 2012/0214013 A1
(43) Pub. Date: Aug. 23, 2012

(54) Method and Apparatus for a Removable and Interchangeable Accessory Addition

(76) Inventor: Anastasia Eugenia Namsaraeva, (US)

(21) Appl. No.: 13/227,179

(22) Filed: Sep. 7, 2011

Related U.S. Application Data
(60) Provisional application No. 61/445,019, filed on Feb. 21, 2011.

(51) Int. Cl. A47G 35/00; A44B 1/00; F16B 2/20; H01F 7/02; A44B 19/00; A44B 17/00; A44B 18/00; A44B 13/00

(52) U.S. Cl. 428/542.2; 24/442; 24/90.1; 24/592.1; 24/303; 24/381; 24/594.11; 24/455

(57) ABSTRACT

An interchangeable and detachable accessory addition to clothing accessories, handbags, shoes, and apparel provides a wide variety of fashionable and easily interchangeable looks. This helps keep the wardrobe compact while at the same time providing a wide variety of fashionable looks. Interchangeable and detachable accessory addition does not tear at clothing, can be easily removed, mixed and matched with ease for the busy Fashionistas on the go.

### CROSS-REFERENCE TO RELATED APPLICATIONS

This application claims the benefit of provisional patent application Ser. No. 61/379,731, filed 2010 Sep. 3 by the present inventor and of provisional patent application Ser. No. 61/445,019, filed on 2011 Feb. 21 by the present inventor.

### BACKGROUND OF THE INVENTION

### Field of Invention

This invention generally relates to fashion, specifically to fashion accessories, clothing accessories, shoes, and handbags.

### SUMMARY

This summary only touches upon several embodiments of the invention. The invention relates to a method and apparatus for an easily removable and interchangeable accessory addition to clothing, hats, shoes, handbags, and accessories, having an inner fastening mechanism to hold and attach the addition to the piece of one of the aforementioned pieces for a decorative purpose. This interchangeable and easily detachable accessory addition can be easily transferred from the body of a handbag with the corresponding method of attachment to a handbag strap with the same method of attachment, thus shifting the focal point and changing the look. In this manner, said addition can be transferred from a handbag to a necklace with the corresponding method of attachment, from a necklace with the said method to a belt with the said method, from the belt to a hair band with the same method of attachment and so on and so forth, creating a wide variety of aesthetic and fashionable looks without damaging any piece of clothing material. Such swift ability to place and remove the accessory addition to create many different looks allows easy experimentation with different fashion styles, mix, match, and pair accessory additions to outfits.

### DRAWINGS

### Figures

In the drawings, closely related figures have the same number but different alphabetic suffixes.

FIG. 1 is a perspective view of the two decorative additions: top detachable accessory addition 32 and base detachable accessory addition 30. These two additions 32 and 30 are sealed around a handbag strap. With Velcro hook and loop fastener 34 in shape of a heart glued and sewn to the top decorative addition 32.

FIG. 2 shows a perspective view of the top addition 32 being detached from the base addition 30, showing the inner attaching mechanism, Velcro 34 strips.

FIG. 3 shows a front side view of the interchangeable decorative detachable addition in form of a flower 48.

FIG. 4 shows a back side view of the decorative addition 48.

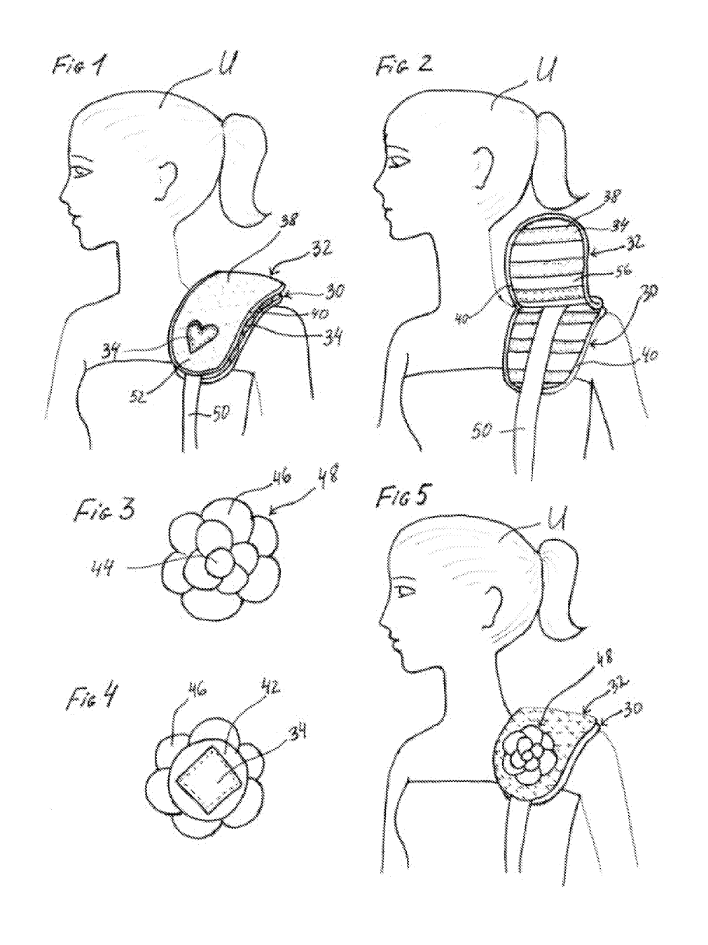

FIG. 5 shows a perspective view with the decorative addition 48 attached to top addition 32

FIG. 6 shows a perspective view of bottom and top decorative additions where the top decorative addition has an embedded decorative design instead of the attaching mechanism.

FIG. 7 shows a perspective view of the top and bottom decorative additions being unsealed, revealing another combination of an inner attaching mechanism. This combination has push clips along with Velcro strips.

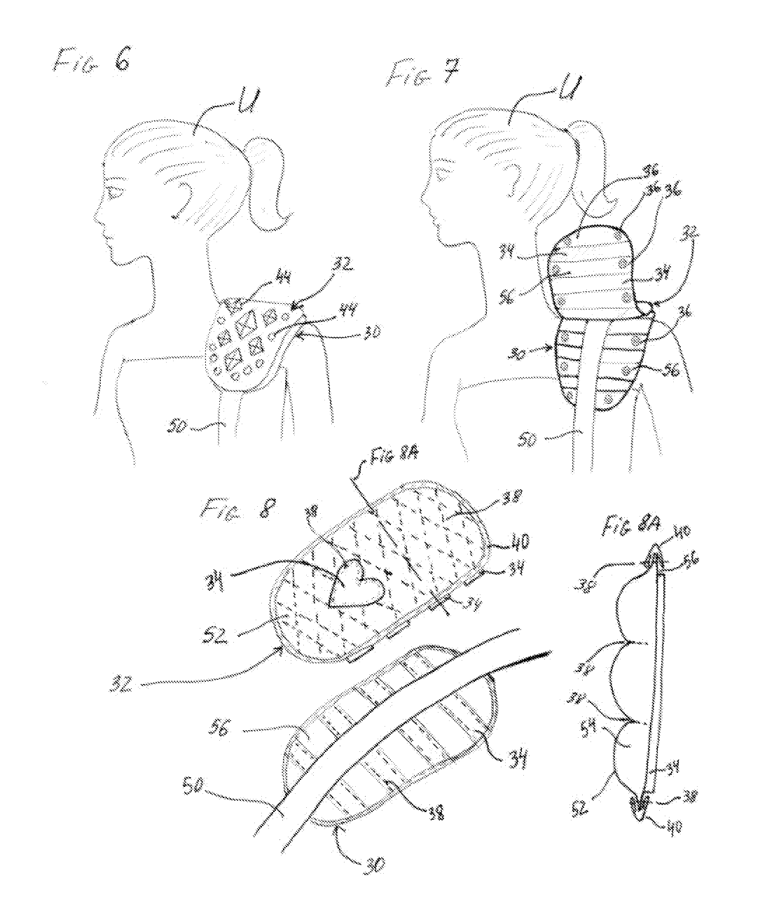

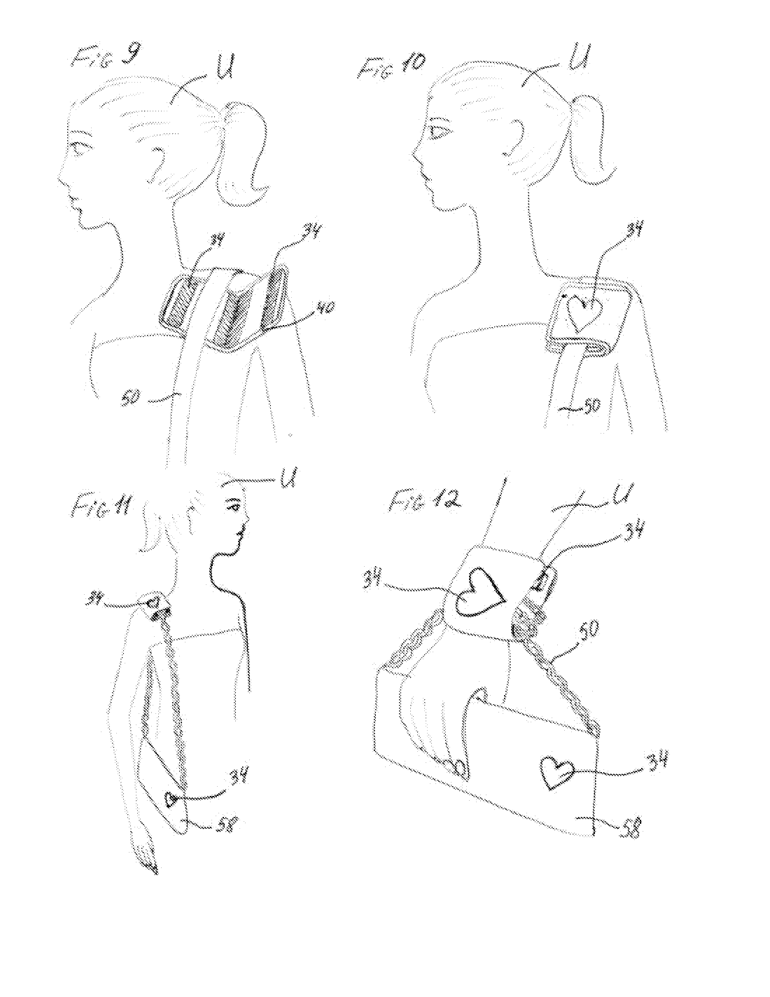

FIG. 8 shows a close up of the two additions

FIG. 8A is a cross-sectional view of the shoulder pad as indicated in FIG. 8.

FIG. 9 shows another decorative addition variation where the top and the bottom parts are one part. Thus, the addition simply folds around a handbag strap. This figure shows an opened decorative addition revealing another variation of Velcro strips placement. The revealed inner mechanism is comprised of Velcro 34 strips parallel to the length of the handbag strap 50.

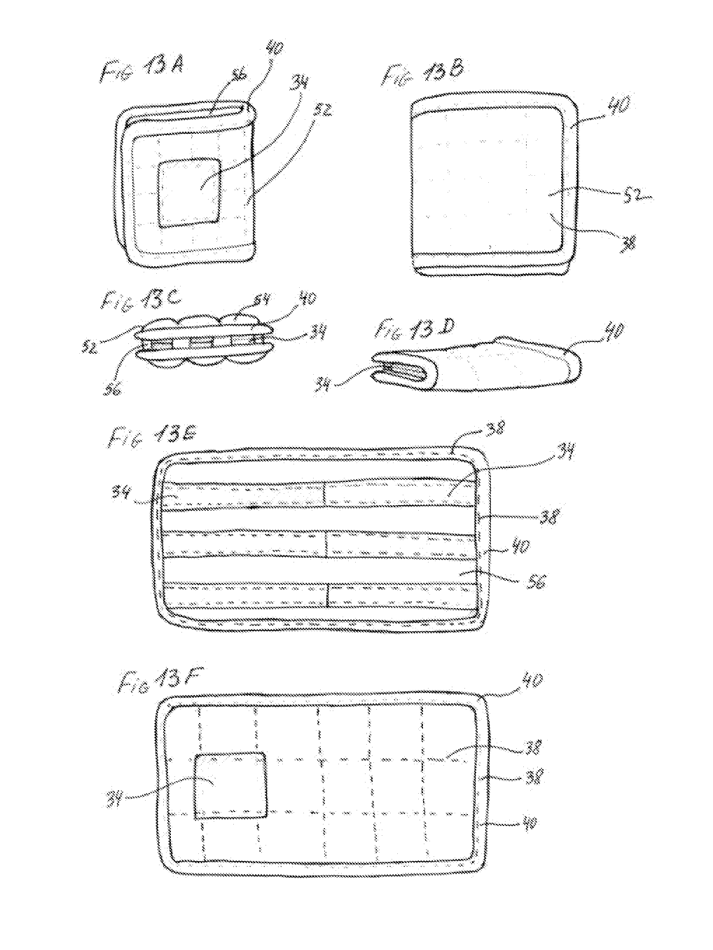

FIG. 10 shows a perspective view of the new variation of the decorative addition sealed around a handbag strap 50.

FIG. 11 shows a perspective view of a person carrying handbag with a chain strap. The handbag has a Velcro attaching mechanism for the decorative addition.

FIG. 12 shows another use of the decorative addition from FIGS. 9-11, where the chain of the handbag illustrated in FIG. 11 is wrapped around the decorative addition, thus shortening the strap, which allows carrying the handbag as a clutch. The decorative addition 48 described in FIG. 2 and FIG. 3 can go either on the decorative addition or the handbag addition 58.

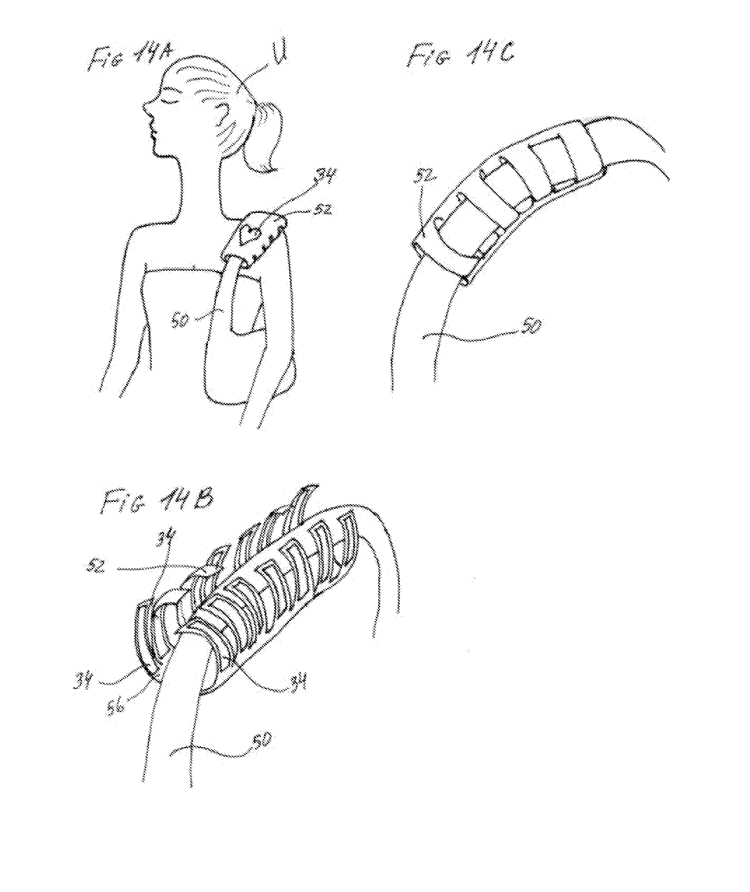

FIG. 13A shows a close-up front view of the decorative addition variation introduced in FIG. 9-12.

FIG. 13B shows a back side view of the decorative addition introduced in FIGS. 9-12.

FIG. 13C shows a close-up of a side view of the decorative addition introduced in FIGS. 9-12.

FIG. 13D shows a close-up of a different side view from the one shown in FIG. 13C.

FIG. 13E shows a close-up of the decorative addition introduced in FIGS. 9-12 opened and the inner attaching mechanism revealed.

13F shows a close-up of the opened decorative addition with its outer side revealed.

FIG. 14A shows a front perspective view of yet another variation of the decorative addition.

FIG. 14B shows a perspective close-up view of the decorative addition sealed around a handbag strap.

FIG. 14C shows a close-up of a back side view of the decorative addition already sealed around a handbag strap.

FIG. 15 shows a handbag in form of a clutch with a Velcro mechanism for the decorative addition.

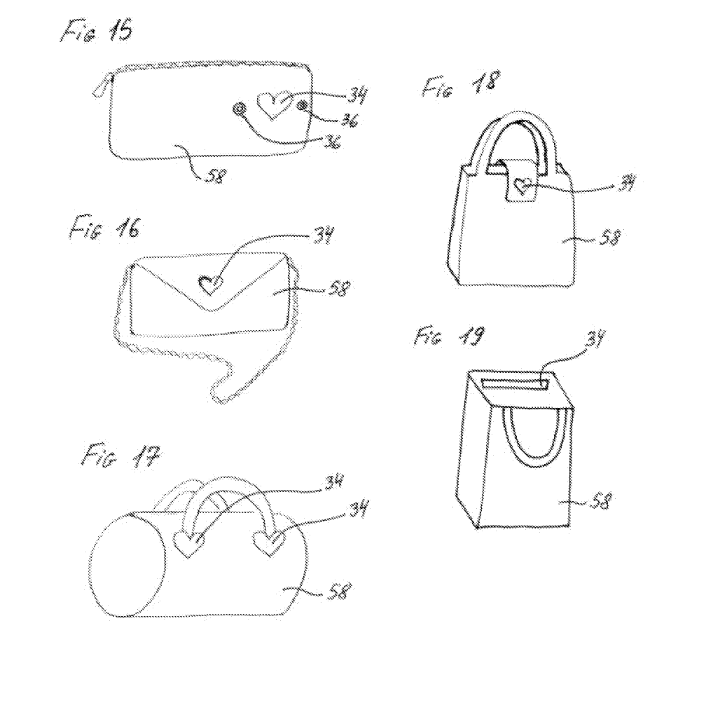

FIG. 16 shows a handbag in form of a purse where the Velcro mechanism is placed on top of the magnetic snap. This type of the decorative addition hides the magnetic snap hardware of a handbag.

FIG. 17 shows a handbag with the decorative addition involving a Velcro mechanism of attachment 34 placed right on top the place where the straps are sewn to the body of a bag. This type of the decorative addition placement hides the stitches.

FIG. 18 shows a tote where the Velcro attaching mechanism 34 is on the closure of a tote.

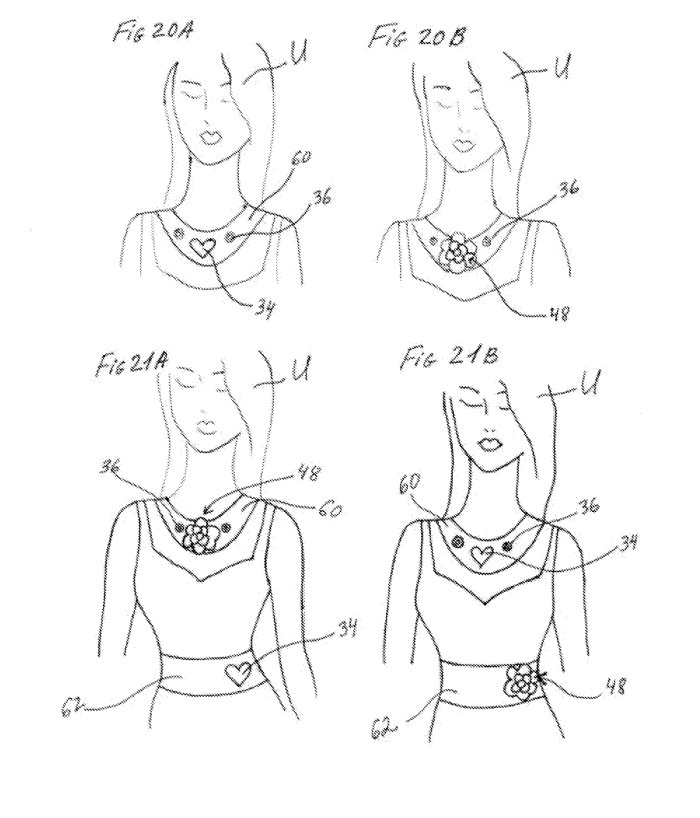

FIG. 19 shows an inner part of a handbag where the Velcro mechanism 34 is placed on the inside wall of the handbag.

FIG. 20A shows a necklace with decorative addition, which is comprised of the Velcro attachment 34 and two push buttons, one on each side of the Velcro attachment mechanism.

FIG. 20B shows the decorative addition from FIG. 3 attached to the decorative addition in form of a necklace from FIG. 20A.

FIG. 21A shows a front view of the decorative addition in form of a belt with Velcro mechanism of attachment 34 in shape of a heart.

FIG. 21B shows a front view of the decorative addition in form of a belt with the decorative addition 48 in form of a flower.

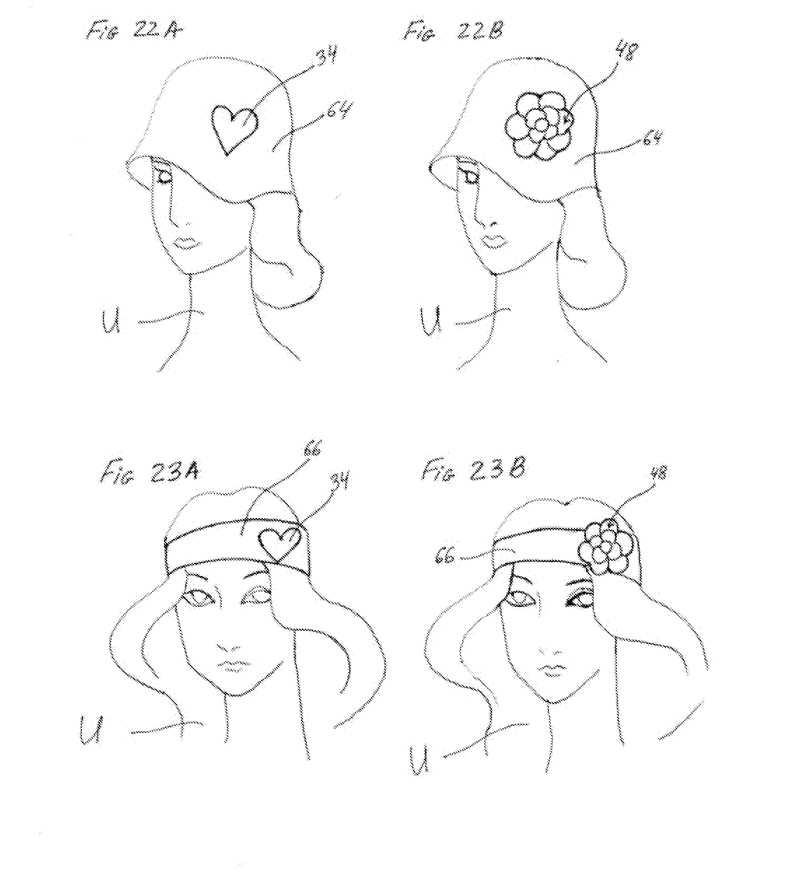

FIG. 22A shows a front view of the decorative addition in form of a hat with the Velcro mechanism of attachment 34 in shape of a heart.

FIG. 22B shows a front view of the decorative addition in form of a hat with the flower decorative addition from FIG. 3.

FIG. 23A shows a front view of the decorative addition in form of a hair band with the Velcro mechanism of attachment 34 in shape of a heart.

FIG. 23B shows the front view of the decorative addition in form of a hair band with the decorative addition in form of a flower from FIG. 3 attached to it.

FIG. 24 shows the front view of the decorative addition in form of shows with a Velcro mechanism of attachment 34 in form of a heart.

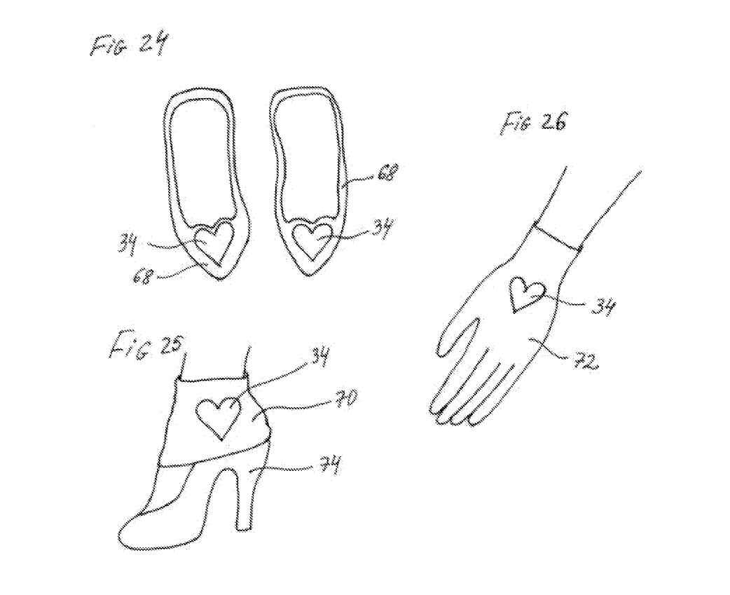

FIG. 25 shows a tube sock version of the decorative addition with a Velcro mechanism of attachment in form of a heart.

FIG. 26 shows a perspective view of the base accessory addition in form of a glove 72 with Velcro 34 mechanism of attachment in form of a heart.

FIG. 27A shows a front view of the decorative addition in form of a bracelet with Velcro mechanism of attachment in shape of a heart.

FIG. 27B shows a back side view of the bracelet decorative addition, where a D ring is sewn into the bracelet to attach clutches, purses, and small handbags.

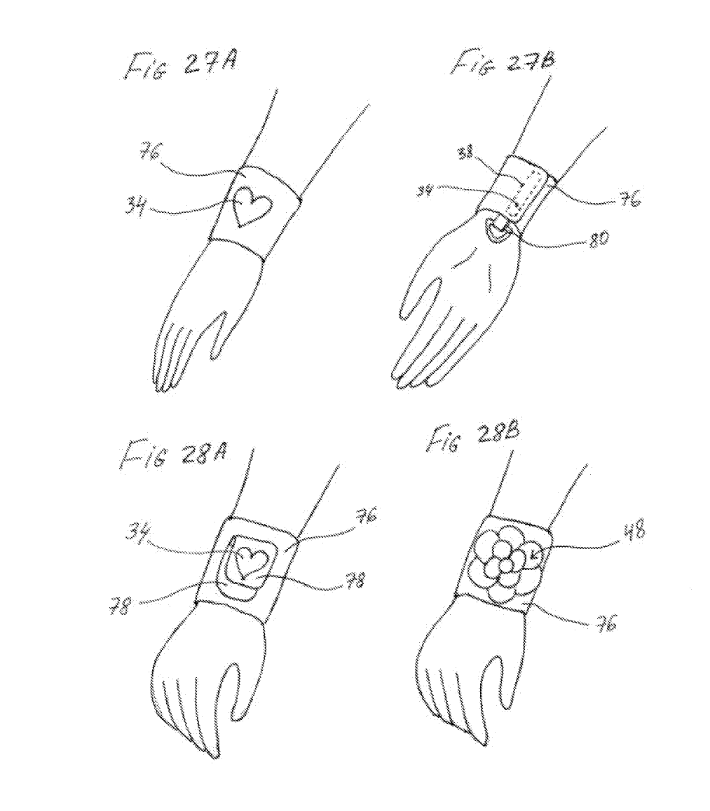

FIG. 28A shows a front view of the bracelet decorative addition with a pocket. The pocket has a closure flap with a Velcro mechanism of attachment in form of a heart.

FIG. 28B shows a front view of the bracelet from FIG. 40 with the decorative addition from FIG. 3.

### REFERENCE NUMERALS

30 Base Detachable Accessory Addition
32 Top Detachable Accessory Addition
34 Velcro hook and loop material with sticky back
36 Snap buttons
38 Stitching
40 Double folded ribbon
42 felt material
44 Decorative bead
46 Silk flower petal
48 Decorative detachable addition in form of a flower
50 Handbag strap
52 outer material, fabric
54 foam material
56 inner material, fabric, facing the strap of a handbag
58 Base accessory addition in form of a handbag
60 Base accessory addition in form of a necklace
62 Base accessory addition in form of a belt
64 Base accessory addition in form of a hat
66 Base accessory addition in form of a hair band
68 Base accessory addition in form of shoes
70 Base accessory addition in form of a tube sock
72 Base accessory addition in form of a glove
74 Shoe
76 Base accessory addition in form of a bracelet
78 Pocket
80 D-ring
U Person showcasing the accessories

### DETAILED DESCRIPTION—FIRST EMBODIMENT—FIGS. 1, 2, 3, 4, 5, 8, 8a

One embodiment of the method and apparatus for a removable and interchangeable decorative addition is illustrated in FIG. 1 through FIG. 5. This embodiment is comprised of three removable and interchangeable decorative additions: base detachable accessory addition 30, top detachable accessory addition 32, and decorative detachable accessory addition 48.

FIG. 1 depicts rectangular shape of the base 30 and top addition 32 with rounded angles, creating an elongated oval base. Top addition 32 is comprised of outer material 52 that is stitched to foam material 54 where predetermined size of foam 54 is matched to the predetermined shape of the top addition 32. Velcro 34 piece, illustrated in this embodiment in the form of a heart, and with a hook texture, is then stitched to the top of the already stitched outer material 52 to foam 54. Velcro 54 in form of strips with predetermined parameters to fit the shape of the predetermined shape of the top addition 32, and having a hook texture, are placed perpendicularly to the length of the top addition 32 and are stitched to the inner material 56. Then, the already stitched outer material 52 to foam 54 is sewn to inner material 56 that already has Velcro 34 strips stitched to it. The inner material 56 covers the foam 54. Outer material 52 and inner material 56 are stitched along the edges of the predetermined shape of the top addition 32. Double folded ribbon 40 is then wrapped around the edges of the material 52, 54, and 56 and stitched to the edges, to cover up the fray.

The same process happens in the making of the base addition 30. Outer material 52 is stitched to foam material 54 with the same predetermined sizes as for top addition 32. Velcro 54 in the shape of a heart is not sewn to the outer material 52 on the base addition 30, since the outer material 52 on the base addition 30 will be placed right against the shoulder. Corresponding to Velcro 34 hook texture on the top addition 32, Velcro 34 strips with loop texture are sewn to the inner material 56 of the base addition 30. Then outer material that is already stitched to foam material 54 is stitched to the inner material 56 that has the Velcro 34 loop. Double folded ribbon is then stitched over the edges of the material 52, 54, and 56 that are sticking out. FIG. 8A provides a cross sectional view of the layers of the top addition.

FIG. 3 depicts a decorative detachable accessory 48 that attaches to the Velcro 34 heart that is located on the top addition 32. Velcro 34 heart illustrated in this embodiment has a hook texture and is placed off center, closer to the edge of the top addition 32. FIG. 4 shows the back side of the decorative addition 48, where Velcro 34 is in shape of a rhombus with a loop texture. Velcro 34 in FIG. 4 is stitched to the felt part 42. In this embodiment, decorative addition 48 is comprised of the silk flower petals that are stitched to the felt material for reinforcement, and then the bead 44 is glued and or sewn to the center of the decorative flower.

### OPERATION—FIRST EMBODIMENT—FIGS. 2, 5, 8

Base addition 30 is placed on top of the shoulder under the strap of a handbag strap 50, as illustrated in FIG. 2. Top addition 32 is then placed over the strap, aligning inner Velcro 34 hook and loop strips, thus sealing around the strap 50. Velcro 34 is in shape of strips, with predetermined parameters, placed perpendicular to the length of the strap 50; provide a tight and secure seal around the strap 50. This way less wide handbag strap 50 would be tightly sealed by the base 30 and top 32 additions. Velcro strips 34 are spaced from each other to provide a bendable apparatus to lay snug and flat against the shoulder to provide a stable surface area for attaching decorative addition 48.

FIG. 5 provides an illustration of how this embodiment creates a fashionable illusion of an asymmetric top, turning regular top into a fashionable garment.

### DESCRIPTION—ALTERNATIVE EMBODIMENT—FIGS. 9-13f

This embodiment has the same essence as the first embodiment, however top and bottom additions, 32, and 30, consequently, are not separated, but combined. The predetermined size of this embodiment is smaller and more compact. FIG. 9 illustrates the parallel positioning of the Velcro 34 strips to the length of the handbag strap 50.

FIG. 13A-13F show different views of this combined addition. To make this embodiment there's only one outside material 52 and one inner material 56. The Velcro strips 34 with hook texture are sewn at one side of the inner material, while the Velcro strips 34 with loop texture are sewn at the opposite end of the inner material. The outer material 52 is stitched to foam material 54. Then Velcro 34 in form of a square with hook texture is place and stitched at one end of the outer mater 52. Then the outer material 52 is stitched to the inner material 56, and the double folded ribbon 40 is stitched over the edges to hide the fraying edges.

### OPERATION—ALTERNATIVE EMBODIMENT—FIG. 11, 12

FIG. 11 and FIG. 12 provide an illustration of different operational uses of this combined addition. FIG. 12 shoes how the strap 50 can be shortened by being wrapped around this embodiment, turning a purse into a clutch that can easily hang around a wrist, letting the hand free.

### DESCRIPTION—ALTERNATIVE EMBODIMENT—FIGS. 14a-14c

This embodiment is also a combined embodiment where top addition 32 and bottom addition 30 are merged. The bottom addition 32 is in form of flaps where each flap has Velcro 34 strip sewn onto it. FIG. 14B illustrates how this embodiment is comprised.

### OPERATION—ALTERNATIVE EMBODIMENT—FIGS. 14a, 14c

FIG. 14C shows how this addition fastens around the strap 50, where every other flap attaches around the strap, creating a tight grip on the strap and creating a sturdy surface for attaching decorative addition 48.

### DESCRIPTION—ALTERNATIVE EMBODIMENT—FIG. 15-19

This embodiment illustrates how a handbag 58 of any shape and form is a base addition. In this embodiment Velcro 34 in shape of a heart is sewn to the outside wall of the bag 58.

### OPERATION—ALTERNATIVE EMBODIMENT—FIGS. 15-19

In FIG. 15 Velcro 34 heart is sewn on the side of the clutch with snap buttons 36 on either side as a possible combination of the fastening systems. In FIG. 16 the Velcro is sewn on top of the hardware to hide the hardware attachment. In FIG. 17 the Velcro 34 in shape of a heart is sewn on each side of a handbag handles to hide the stitching of the handles where they are attached to the body of the bag 58. In FIG. 18 Velcro 34 heart with a hook texture is sewn over a closure clasp to hide the hardware. In FIG. 19 the Velcro strip is sewn to the inside of the bag 58 to attach additional decorative accessories that are in a form of a mirror, wallet, keychain, so there's an easy access to all these necessary items.

### DESCRIPTION—ALTERNATIVE EMBODIMENT—FIGS. 20a-20b

This embodiment shows a Velcro 34 heart sewn to the base accessory addition in form of a necklace base 60. There are also additional snap buttons on either side as a possible combination of the fastening systems.

### OPERATION—ALTERNATIVE EMBODIMENT—FIG. 20b

Shows decorative addition 48 attached to the necklace base 60 for a different fashionable look.

### DESCRIPTION—ALTERNATIVE EMBODIMENT—FIGS. 21a-20b

This embodiment shows a Velcro 34 heart sewn to the base accessory addition in form of a belt 62.

### OPERATION—ALTERNATIVE EMBODIMENT—FIG. 21b

Shows decorative addition 48 attached to the belt base 62 for a different fashionable look.

### DESCRIPTION—ALTERNATIVE EMBODIMENT—FIGS. 22a-22b

This embodiment shows a Velcro 34 heart sewn to the base accessory addition in form of a hat 64.

### OPERATION—ALTERNATIVE EMBODIMENT—FIG. 22b

Shows decorative addition 48 attached to the hat base 64 for a different fashionable look.

### DESCRIPTION—ALTERNATIVE EMBODIMENT—FIGS. 23a-23b

This embodiment shows a Velcro 34 heart sewn to the base accessory addition in form of a hair band 66.

### OPERATION—ALTERNATIVE EMBODIMENT—FIG. 23b

Shows decorative addition 48 attached to the necklace base 60 for a different fashionable look.

### DESCRIPTION—ALTERNATIVE EMBODIMENT—FIG. 24

This embodiment shows a Velcro 34 heart sewn to the base accessory addition in form of shoes 68. The Velcro 34 in form of a heart is stitched the shoe addition 68.

### DESCRIPTION—ALTERNATIVE EMBODIMENT—FIG. 25

This embodiment shows a Velcro 34 heart sewn to the base accessory addition in form of a tube sock 70. Tube sock goes over the regular shoe 74.

### OPERATION

### Alternative Embodiment

This embodiment allows decorative addition 48 to be worn around one's shoe creating a fashionable look.

### DESCRIPTION

### Alternative Embodiment—FIG. 26

This embodiment shows a Velcro 34 heart sewn to the base accessory addition in form of a glove 72.

### OPERATION

### Alternative Embodiment

This embodiment allows using one pair of gloves while creating many different looks by interchanging decorative additions such as decorative addition 48.

### DESCRIPTION

### Alternative Embodiment—FIGS. 27a-28b

This embodiment shows a Velcro 34 heart sewn to the base accessory addition in form of a bracelet 76. This embodiment illustrates that the bracelet closes using Velcro 34 strip, where stitching 38 shows the place where the Velcro 34 strip is sewn. There's additional D-ring 80 attaching mechanism sewn together with the strip.

### OPERATION

### Alternative Embodiment—FIG. 27b

D-ring 80 provides capability for a clutch, purse, and keychain to be attached to it and carried without having to hold it in a palm of a hand. FIG. 28A illustrates a bracelet having a pocket attached to it with a Velcro 34 heart sewn on top of the closing flap 78.

### CONCLUSION, RAMIFICATIONS, AND SCOPE

While the above descriptions contain much specificities, these should not be construed as limitations on the scope of any embodiment, but as exemplifications of the presently preferred embodiments thereof. Many other ramifications and variations are possible within the teachings of the various embodiments. For example, Velcro part may have different shapes and sizes. Besides heart shape it may be round, square, triangular. Attaching mechanism may include other fastening systems, and combinations. The set up of the inner fastening mechanism may also vary. The design may be embedded as opposed to being attached by Velcro mechanism.

In addition, in all featured drawings FIG. 48 has the same decorative shape for the simplicity of demonstration of its use with all of the aforementioned embodiments; however, decorative additions can take on many forms. By having a wide variety of shapes, colors, and sizes of decorative additions one can interchange accessories in any desirable way. This way the removable and interchangeable accessory addition keeps wardrobe compact while creating a wide variety of fashionable looks.

Thus, the scope of the invention should be determined by the appended claims and their legal equivalents, and not by the examples given.

I claim method and apparatus for a:

1. Removable and interchangeable decorative addition to clothing, hats, shoes, handbags and accessories, having an inner fastening mechanism to hold and attach the addition to the piece of one of the aforementioned pieces for decorative purpose.

2. The addition according claim 1, wherein it is used for decorative purpose on handbag handles, purses, clutches, totes, musical instrument cases or any other carrying devices using straps.

3. The method of claim 2 wherein the said addition attaches to the mentioned piece by detachable mechanism such as but not limited to Velcro, hook and loop fastening, push buttons, hooks, buttons, zippers, magnets, rivets, snaps, clips, and any combination of the aforementioned fastening elements.

4. The addition according to claim 3 wherein the place of attachment is located on the facade of the bag; on the inner wall of the bag; on the shoulder area of the strap of the bag; near area where handles are connected to the bag; on top of the handbag closures.

5. The addition according to claim 1, wherein the addition is a decorative element in a form of flowers, cameos, fruits, birds, insects, toys, animals, geometric shapes, fashionable shapes, patterns, colors, and textures.

6. The decorative element of 5 wherein it is made of such materials but not limited to: fabric, fur, leather, foam, feather, ribbon, lace, stones, plastic, beads, studs, metals, precious metals, any form of mixed plastic, rubber, and any combination of aforementioned materials to create visually pleasing and fashion forward ensemble.

7. The decorative addition of claim 1 wherein it is attached to a handbag strap or multiple straps using mechanism of attachment explained in claim 3, made out of decorative elements explained in claim 5, and material explained in claim 6.

8. The decorative addition of claim 1 wherein it is attached to a hat using mechanism of attachment explained in claim 3, made out of decorative elements explained in claim 5, and material explained in claim 6.

9. The decorative addition of claim 1 wherein it is attached to a hair band using mechanism of attachment explained in claim 3, made out of decorative elements explained in claim 5, and material explained in claim 6.

10. The decorative addition of claim 1 wherein it is attached to shoes, and shoe tube using mechanism of attachment explained in claim 3, made out of decorative elements explained in claim 5, and material explained in claim 6.

11. The decorative addition of claim 1 wherein it is attached to a waist belt using mechanism of attachment explained in claim 3, made out of decorative elements explained in claim 5, and material explained in claim 6.

12. The decorative addition of claim 1 wherein it is attached to a necklaces using mechanism of attachment explained in claim 3, made out of decorative elements explained in claim 5, and material explained in claim 6.

13. The decorative addition of claim 1 wherein it is attached to a necklaces using mechanism of attachment explained in claim 3, made out of decorative elements explained in claim 5, and material explained in claim 6.

14. The decorative addition of claim 1 wherein it is attached to gloves using mechanism of attachment explained in claim 3, made out of decorative elements explained in claim 5, and material explained in claim 6.

15. The decorative addition of claim 1 wherein it is attached to a bracelet using mechanism of attachment explained in claim 3, made out of decorative elements explained in claim 5, and material explained in claim 6.
